(19) United States
(12) Patent Application Publication
(10) Pub. No.: US 2025/0077143 A1
(43) Pub. Date: Mar. 6, 2025

(54) INFORMATION PROCESSING APPARATUS, METHOD FOR SETTING LONG SHEET PRINTING, AND IMAGE FORMING APPARATUS

(71) Applicant: SHARP KABUSHIKI KAISHA, Osaka (JP)

(72) Inventors: Seigo NAKAMURA, Osaka (JP); MASAHIRO KAWANO, Osaka (JP); Hirofumi UCHIYAMA, Osaka (JP)

(21) Appl. No.: 18/822,378

(22) Filed: Sep. 2, 2024

(30) Foreign Application Priority Data
Sep. 1, 2023 (JP) 2023-142388

(51) Int. Cl. G06F 3/12

(52) U.S. Cl. CPC G06F 3/1252; G06F 3/1208

(57) ABSTRACT

An information processing apparatus communicating with an image forming apparatus that includes an image former that forms an image on a long sheet and a creasing mechanism that provides a crease for folding to the long sheet at multiple sites in a longitudinal direction, includes a controller that receives a setting for a job related to the image formation and sends an instruction to the image forming apparatus, wherein the controller performs: receiving a selection of the long sheet, a setting of a creasing function that provides the crease to the selected long sheet, and a setting of a position of the crease; determining the position where the crease is provided according to the setting; and displaying a display image corresponding to the selected long sheet on which the display image of a print document and the position of the crease are superimposed, thereby receiving the setting of the position of the crease.

### CROSS-REFERENCE TO RELATED APPLICATION

The present application claims priority from Japanese Application JP2023-142388, the content of which is hereby incorporated by reference into this application.

### BACKGROUND OF THE INVENTION

### 1. Field of the Invention

The present disclosure relates to an information processing apparatus that sends a job instruction related to image formation to an image forming apparatus, a method for setting long sheet printing, and an image forming apparatus.

### 2. Description of the Related Art

An image forming apparatuses capable of performing saddle stitch printing, in which a document is folded in half and stapled in two central positions, is known. Regarding the saddle-stitch printing, the following image output system has been proposed as a system that achieves the borderless saddle stitch printing by trimming the margin on only one side, eliminating the need to trim the margins on three or two sides. The system includes an image forming apparatus and an information processing apparatus having a function of instructing the image forming apparatus to perform output processing. The image forming apparatus includes a printer that performs the saddle stitch printing using a recording medium, a saddle stitch processer that performs the saddle stitch processing using the recording medium, and a trimmer that trims an end of the recording medium. The printer has a function of performing the top/bottom borderless printing. Further, the trimmer has a function of trimming one side of the fore edge of the recording medium that has been subjected to the saddle stitch processing. The image forming apparatus, in response to an instruction from the information processing apparatus, trims the one side of the fore edge of the recording medium that has subjected to the saddle stitch processing after the top/bottom borderless printing.

The saddle stitch printing is a typical mode of printing that involves paper folding. For example, folding an A3-sized sheet in the center along the long side and preforming the saddle stitch using a stapler can produce a booklet with each page being A4-sized. Performing the saddle stitch printing using a double letter-sized sheet can produce a booklet with each page being letter-sized.

On the other hand, a long sheet is known, which is not of the common size known as a standard size and is used for limited purposes such as banner printing. The long sheet is a general term for a sheet that is longer than the standard size in one direction. A relatively common example of the long sheet is the one with a length in the top/bottom direction of 297 mm, the same as the long side length of an A4 sized paper, and a length in the longitudinal direction of 900 mm or 1200 mm. These are typical sizes used for the banner printing, and an image forming apparatus such as a printer or a multifunction machine compatible with printing using these long sheets (long-length printing) is known.

### SUMMARY OF THE INVENTION

The printing with paper folding is not limited to the saddle stitch printing. For example, some restaurant menus and catalogs are folded in thirds and come in the standard size (typically A4 size or letter size). An image forming apparatus compatible with the long-length printing may be able to handle such a printed matter. However, the setting is complicated for printing using a non-standard sized sheet that is subject to paper folding, and it is difficult for a user to set up such a print job.

The present disclosure has been made in consideration of the above circumstances and provides an information processing apparatus that can easily perform a setting related to a print job that finishes a long sheet with a crease for folding.

The present disclosure provides an information processing apparatus which is capable of communicating with an image forming apparatus that includes an image former that forms an image on a long sheet and a creasing mechanism that provides creases for folding to the long sheet at multiple sites in a longitudinal direction and includes a controller that receives a setting of a job related to the image formation and sends an instruction to the image forming apparatus. The controller receives a selection of the long sheet, a setting of a creasing function that provides the creases to the selected long sheet, and a setting of positions of the creases, determines the positions where the creases are provided according to the setting, and displays, on a screen of the information processing apparatus, a display image corresponding to the selected long sheet on which the display image of a print document and the positions of the creases are superimposed, thereby receiving the setting of the positions of the creases.

Further, the present disclosure in a different aspect provides a method for setting long sheet printing in which, in an information processing apparatus capable of communicating with an image forming apparatus that includes an image former that forms an image on a long sheet and a creasing mechanism that provides creases for folding to the long sheet at multiple sites in a longitudinal direction, a controller that receives a setting for a job related to the image formation and sends an instruction to the image forming apparatus performs receiving a selection of the long sheet, a setting of a creasing function that provides the creases to the selected long sheet, and a setting of positions of the creases, and determining the positions where the creases are provided according the setting. In the step of receiving the setting, the controller displays, on a screen of the information processing apparatus, a display image corresponding to the selected long sheet on which the display image of a print document and the positions of the creases are superimposed, thereby receiving the setting of the positions of the creases.

Further, the present disclosure provides an image forming apparatus that includes an image former that forms an image on a long sheet, a creasing mechanism that provides creases for folding to the long sheet at multiple sites in a longitudinal direction, a communication circuit that communicates with an external information processing apparatus, and a job controller that performs processing in response to a job setting and instruction related to the image formation received from the information processing apparatus via the communication circuit. When the received job setting includes a creasing function, the job controller performs control for forming the image on the specified long sheet and provision of the creases at specified positions on the long sheet.

In the information processing apparatus according to the present disclosure, the controller displays, on a screen, the display image corresponding to the selected long sheet on which the display image of the print document and the positions of the creases are superimposed, thereby receiving the setting of the positions of the creases. This makes it easy to perform the setting related to the print job that finishes the long sheet with the creases for folding. The method for setting the long sheet printing according to the present disclosure also achieves the same advantageous effects.

### BRIEF DESCRIPTION OF THE DRAWINGS

FIG. 1 is an explanatory diagram showing an external appearance of a multifunction machine as an example of a printer according to the present disclosure, viewed diagonally from the left front side.

FIG. 2 is a block diagram showing a configuration of the multifunction machine shown in FIG. 1 and an information processing apparatus capable of communicating with the multifunction machine.

FIG. 3 is an explanatory diagram showing a configuration of a pre-processer shown in FIG. 1.

FIG. 4 is an explanatory diagram showing an example of a print setting screen which a driver causes the information processing apparatus to display in an embodiment of the present disclosure.

FIG. 5 is an explanatory diagram showing an example of sizes related to creasing of a long sheet among sizes selectable in a setting item of an output paper size shown in FIG. 5.

FIG. 6 is an explanatory diagram schematically showing an image printed on the long sheet in an embodiment of the present disclosure (Embodiment 1).

FIG. 7 is an explanatory diagram schematically showing the image printed on the long sheet in an embodiment of the present disclosure (Embodiment 2).

FIG. 8 is an explanatory diagram schematically showing the image printed on the long sheet in an embodiment of the present disclosure (Embodiment 3).

FIG. 9 is an explanatory diagram showing an example of the print setting screen different from that in FIG. 4.

FIG. 10 is an explanatory diagram showing an example of the print setting screen different from those in FIG. 4 and FIG. 9.

FIG. 11 is an explanatory diagram showing an example of the print setting screen different from those in FIG. 4, FIG. 9, and FIG. 10.

FIG. 12 is an explanatory diagram showing an example of a long paper 3-panel setting screen displayed by the driver in an embodiment of the present disclosure.

FIG. 13 is an explanatory diagram showing an example of a detailed screen displayed by the driver in an embodiment of the present disclosure.

### DETAILED DESCRIPTION OF THE INVENTION

The present disclosure is described in more detail below with reference to the drawings. Note that the following description is illustrative in all respects and should not be construed as limiting the present disclosure.

### Configurations of Image Forming Apparatus and Pre-Processer

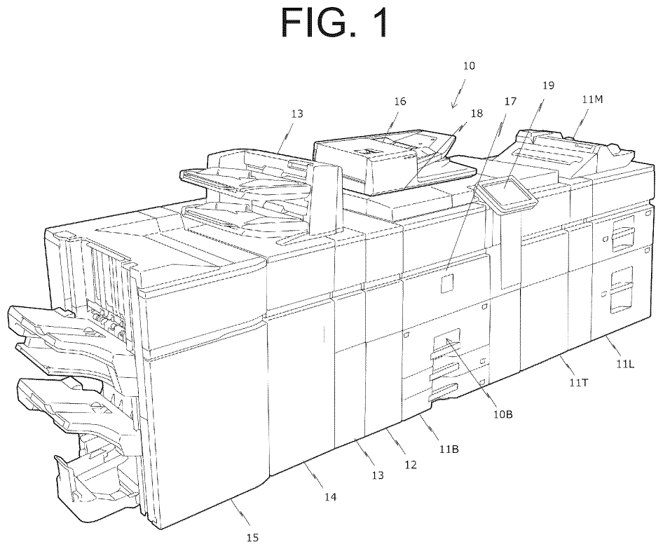

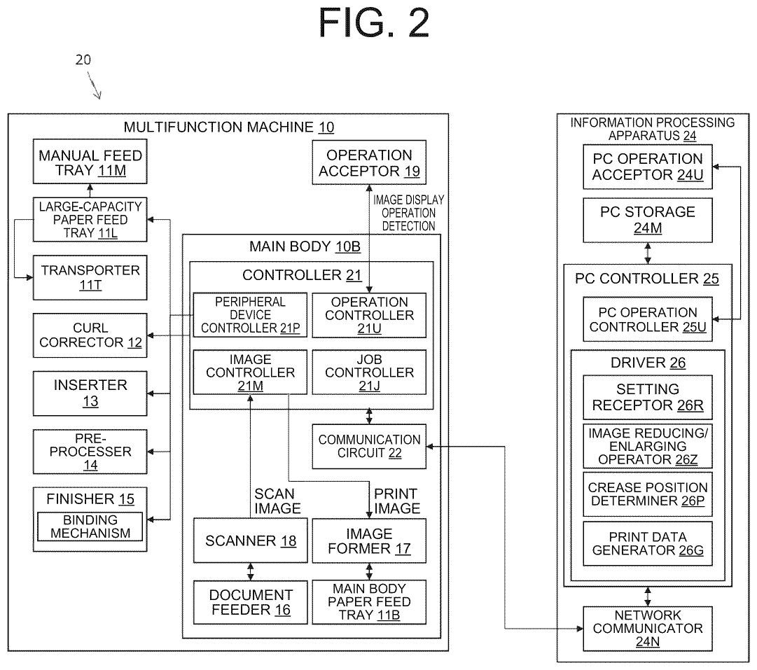

FIG. 1 is an explanatory diagram showing the external appearance of a multifunction machine as an example of an image forming apparatus to which a driver according to the present disclosure sends a job instruction. FIG. 2 is a block diagram showing a configuration example of an image forming system including the driver according to the present disclosure. An image forming system 20 shown in FIG. 2 includes a multifunction machine 10 shown in FIG. 1, an information processing apparatus 24 capable of communicating with the multifunction machine 10, and a driver 26 in the information processing apparatus 24.

The multifunction machine 10 shown in FIG. 1 includes a main body 10B to which peripheral devices are connected. The main body 10B includes a main body paper feed tray 11B, a document feeder 16, an image former 17 that forms an image, a scanner 18 that reads an image on a document, and an operation acceptor 19. A large-capacity paper feed tray 11L, a manual feed tray 11M, and a transporter 11T are connected to the right side of the main body 10B when viewed from the front. A sheet is fed from any of the main body paper feed tray 11B, the large-capacity paper feed tray 11L, and the manual feed tray 11M. A curl corrector 12, an inserter 13, a pre-processer 14, and a finisher 15 are connected to the left side of the main body 10B when viewed from the front. The pre-processer 14 in this embodiment can provide a crease for folding to the sheet. In addition, the pre-processer 14 can perform two-hole punch and multi-hole punch processing in an alternative manner. The finisher 15 can staple documents in one or two places using a stapler. That is, the finisher 15 includes a binding mechanism of the present disclosure.

The main body 10B includes a controller 21 that controls an operation and processing of the multifunction machine 10. The controller 21 is mainly configured with a processor as hardware, and includes a storage configured with a RAM and a non-volatile memory, an input/output circuit, a timer circuit, and the like. Further, the main body 10B includes a communication circuit 22 that communicates with external equipment such as the information processing apparatus 24, and the operation acceptor 19 related to a user interface.

The processor of the controller 21 achieves functions of an operation controller 21U, a job controller 21J, a peripheral device controller 21P, and an image controller 21M shown in FIG. 2. The operation controller 21U causes the operation acceptor 19 to display an operation screen to recognize a user operation performed on the operation screen and perform processing according to the operation. The job controller 21J controls execution of a job using, for example, the scanner 18 and the image former 17. A print job is performed using the image former 17.

The peripheral device controller 21P controls peripheral devices such as the large-capacity paper feed tray 11L, the pre-processer 14, and the finisher 15 connected to the main body 10B. The image controller 21M processes the image of the document read by scanner 18. Further, the image controller 21M processes print data to generate image data to be printed by the image former 17. In a case of the print job, for example, the print data is received from the driver 26 of the information processing apparatus 24 connected via the communication circuit 22.

The information processing apparatus 24 shown in FIG. 2 is equipment that is communicably connected to the multifunction machine 10. The information processing apparatus 24 shown in FIG. 2 is assumed to be a personal computer (PC) as a specific mode. However, the information processing apparatus of the present disclosure is not limited to the PC, and may be, for example, an information terminal such as a smartphone or a tablet terminal. The information processing apparatus 24 includes a PC operation acceptor 24U, a PC controller 25 (controller), a PC storage 24M, and a network communicator 24N.

The PC operation acceptor 24U is a device related to the user interface and includes a display device such as a monitor that displays a screen, and an input device such as a keyboard or a mouse that receives a user operation. The PC storage 24M is configured with a RAM and a non-volatile memory and stores a program and data of an operating system, an application, a driver, and the like. The PC controller 25 is configured with a processor-centered circuit as hardware and executes the program stored in the PC storage 24M to perform the processing as the operating system, the application, the driver, and the like. The network communicator 24N is hardware and software related to communication for the information processing apparatus 24 to communicate with the external equipment such as the multifunction machine 10.

The PC controller 25 includes a PC operation controller 25U and the driver 26. The PC operation controller 25U causes the PC operation acceptor 24U to display an operation screen to recognize a user operation performed on the operation screen and perform processing according to the operation. The driver 26 includes a setting receptor 26R. Further, the driver 26 includes, as a printer driver, an image reducing/enlarging operator 26Z, a crease position determiner 26P, and a print data generator 26G.

The setting receptor 26R causes the PC operation acceptor 24U to display a driver operation screen via the PC operation controller 25U to receive the user setting related to the job to be executed by the multifunction machine 10. Regarding the print job, the setting receptor 26R causes the PC operation acceptor 24U to display a printer driver operation screen to receive the user setting. In this embodiment, the user setting includes a selection of the sheet to be used, a setting of a creasing function for providing a crease to the sheet, and a setting of top/bottom borderless printing. The image reducing/enlarging operator reduces or enlarges the image of the print document according to the setting. When the top/bottom borderless printing is set, the image reducing/enlarging operator determines an enlargement ratio for minimizing the top/bottom margin areas of the print document, and instructs the image of the print document to be enlarged and printed at the determined enlargement ratio. The print data generator 26G generates the print data for causing the image former 17 of the multifunction machine 10 to form an image and print the image on the selected sheet based on the setting received by the setting receptor 26R. Then, the generated print data is sent to the multifunction machine 10 via the network communicator 24N.

FIG. 1 and FIG. 2 show how the peripheral devices such as the pre-processer 14 and the finisher 15 are connected to the main body 10B. However, they may be configured as one apparatus. In this mode, the printer, the finisher, and the like are configured as an integrated apparatus.

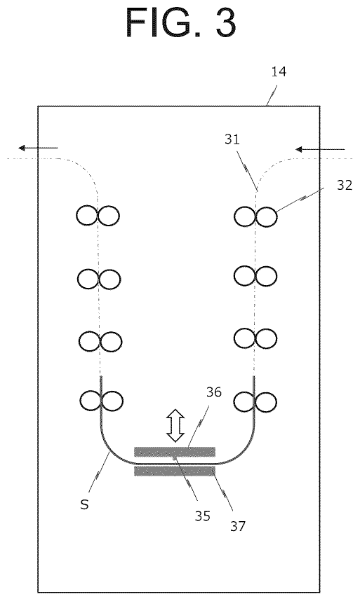

FIG. 3 is an explanatory diagram showing a configuration example of the pre-processer shown in FIG. 1. As shown in FIG. 3, the pre-processer 14 includes a U-shaped transport path 31 in which a plurality of transport rollers 32 are arranged. When the pre-processer 14 performs a creasing process, a presser 36 including a projection 35 and a receiver 37 are installed so as to sandwich the bottom of the U-shaped transport path 31. The presser 36 including the projection 35 is made of a hard member, for example, steel, and is movable in the vertical direction (see an arrow in FIG. 3) by an eccentric cam, a spring, and the like, not shown in FIG. 3. The receiver 37, which face the presser 36 across the bottom of the U-shaped transport path 31, is made of a flexible material such as rubber, and is fixed in position.

The peripheral device controller 21P guides a sheet S printed by the image former 17 of the main body 10B to the transport path 31. When a sensor not shown in FIG. 3 detects that the center of the sheet S has reached a position where it passes under the projection 35 (see the sheet S shown in FIG. 3), the transport of the sheet S is temporarily stopped, and the presser 36 is lowered to press the sheet S against the receiver 37. In this manner, the sheet S sandwiched between the presser 36 and the receiver 37 is provided with a crease in a direction perpendicular to the transport direction. Thereafter, the presser 36 is raised to restart the transport of the sheet S.

Note that the long sheet is fed from the manual feed tray 11M so that the longitudinal direction of the long sheet coincides with the transport direction. In this embodiment, the peripheral device controller 21P performs the operation of providing the crease to the long sheet twice, so that the creases are provided at two positions in the top/bottom direction. The creasing is effective for a sheet with a high basis weight (mass per unit area of base paper). According to this aspect, the pre-processer 14 can provide the creases for 3-panel at two positions on the long sheet.

### Driver Operation Screen and Job Setting

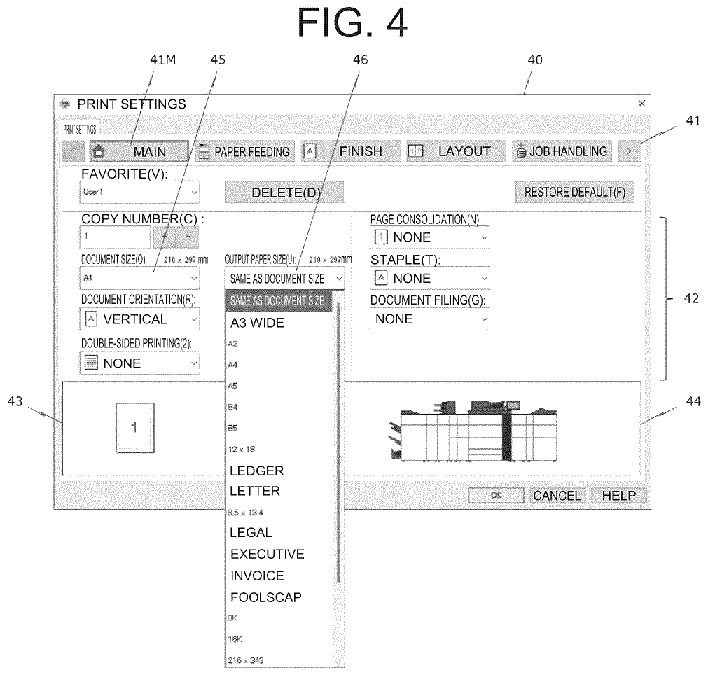

FIG. 4 and FIG. 9 to FIG. 11 are explanatory diagrams showing examples of operation screens of the driver 26, which the PC controller 25 of the information processing apparatus 24 causes the PC operation acceptor 24U to display.

The operation screen shown in FIG. 4 is an example of the operation screen related to print settings. At the top of a print setting screen 40, multiple tabs 41 that categorize settings by category are arranged side by side. Since all the tabs cannot be displayed at once on the print setting screen 40, the tabs can be scrolled by operating scroll buttons on both left and right ends. The driver 26 displays setting items corresponding to the selected tab in a setting area 42 in the middle section.

FIG. 4 shows a state where a [Main] tab 41M is selected. The driver 26 as the setting receptor 26R displays the setting items related to the selected tab in the setting area 42 to receive the setting. The displayed settings items vary depending on the configuration of the connected peripheral equipment. The driver 26 displays a machine illustration 44 showing the current equipment configuration in the right half of the lower section of the print setting screen 40. Further, the driver 26 also displays, in the left half of the lower section, an illustration showing a print finish state according to the set function and an icon according to the finish setting as a print image 43.

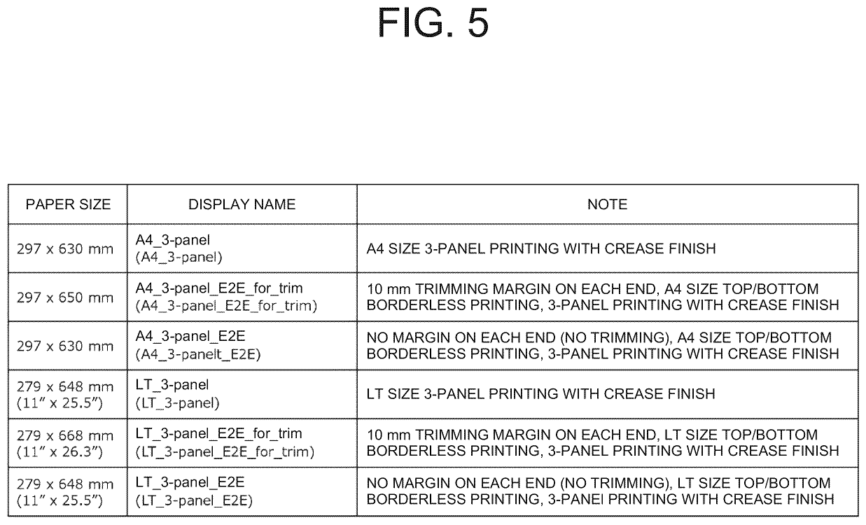

The driver 26 displays a [Document size] 45 and a [Output paper size] 46 as parts of the setting items in the left half of the setting area 42. As shown in FIG. 4, the driver 26 as the setting receptor 26R receives the selection of one of a plurality of paper sizes that can be printed by the multifunction machine 10. FIG. 5 shows some paper sizes related to creasing of the long sheet among the sizes that can be selected as the [Document size] 45 and the [Output paper size] 46. All of the 6 long sheets shown in FIG. 5 can be folded in two positions along the longitudinal direction to form the commonly used standard sizes such as the letter size and the A4 size. The top 3 sizes become the A4 size when folded in thirds, and the bottom 3 sizes become the letter size when folded in thirds. Note that, in FIG. 5, a “Paper size” column indicates sizes of the long sheet in the top/bottom direction and the longitudinal direction. A “Display name” column shows an example of the name of each long sheet that is displayed as an option in the [Original size] 45 and the [Output paper size] 46. The top row shows an example of the display name in Japanese, and the bottom row in parentheses shows an example of the display name in English.

### Embodiment 1

Job with “A4_3-Panel” Set as Output Paper Size

For example, it is assumed that the A4 size is selected as the [Document size] 45, the long sheet size “A4_3-panel” shown in FIG. 5 is selected as the output paper size, and other items are set to the specified conditions described below. In that case, the driver 26 sends, to the multifunction machine 10, the print job for providing the creases for 3-panel to the long sheet of the selected size. The print job includes print data related to the job generated by the print data generator 26G, the setting received by the setting receptor 26R, and data on the crease positions determined by the crease position determiner 26P. Then, the driver 26 causes the multifunction machine 10 to execute the print job according to the setting. Note that the user places the long sheet corresponding to the selected output paper size on the manual feed tray 11M for paper feeding.

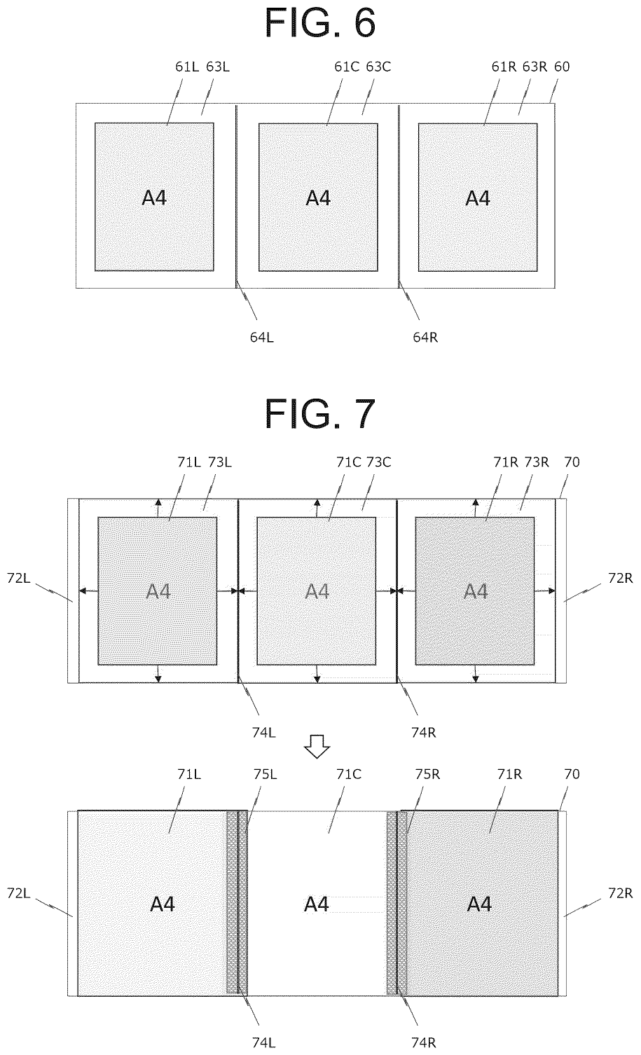

FIG. 6 is an explanatory diagram that schematically shows an image printed on the long sheet by the above-mentioned job. As shown in FIG. 6, the image printed on a long sheet 60 of the “A4_3-panel” size is configured with print documents 61L, 61C, and 61R of the A4 size arranged adjacently in the longitudinal direction. The length in the longitudinal direction of each of the print documents 61L, 61C and 61R is 210 mm, and the length in the longitudinal direction of these print documents adjacently arranged is 630 mm, which is equal to the length of “A4_3-panel” in the longitudinal direction. When “A4_3-panel” is selected as the output paper size, the driver 26 provides margin areas on four edges of each print document, just as in normal printing, that is, when the top/bottom borderless printing is not performed. That is, a margin area 63L having no image is provided on the four edges of the print document 61L, a margin area 63C is provided on the four edges of the print document 61C, and a margin area 63R is provided on the four edges of the print document 61R. The driver 26 as the crease position determiner 26P determines an initial position of a cease 64L on the left side at a boundary position between the print documents 61L and 61C. The position is 210 mm away from the left end. An initial position of a cease 64R on the right side is a boundary position between the print documents 61C and 61R. The position is 420 mm away from the left end. As described below, the positions of the ceases 64L and 64R are each adjustable.

The above is the job for printing with creases for 3-panel when the A4 size is set as the [Document size] 45, “A4_3-panel” is set as the [Output paper size] 46, and other items are set to the specified conditions. On the other hand, both the [Document size] 45 and the [Output paper size] 46 may be set to “A4_3-panel”. This setting is made when the print document of the “A4_3-panel” size is created by an application. In this case, the driver 26 as the print data generator 26G generates the print data in which the margin areas are provided on the four edges according to the size of the selected long sheet. The job in which “A4_3-panel” is set as the [Output paper size] 46 has been described. When “LT_3-panel” (the size of the long sheet shown in the fourth column of FIG. 5) is set as the [Output paper size] 46, the job is the same as for “A4_3-panel”, except that the size when folded in thirds is the letter size.

### Embodiment 2

Job with “A4_3-Panel_E2E_for_Trim” Set as Output Paper Size

Next, a case is described where the A4 size is selected as the [Document size] 45, the long sheet size “A4_3-panel_E2E_for_trim” shown in FIG. 5 is selected as the output paper size, and other items are set to specified conditions. As in the case where “A4_3-panel” is set, the driver 26 sends to the multifunction machine 10 the print job for providing the creases for 3-panel to the long sheet of the selected size.

FIG. 7 is an explanatory diagram that schematically showing an image printed on the long sheet by the above-mentioned job. As shown in FIG. 7, print documents 71L, 71C, and 71R of the A4 size are arranged adjacently in the longitudinal direction, enlarged at a magnification that results in the top/bottom borderless printing, and printed on a long sheet 70 of the size “A4_3-panel_E2E_for_trim”. The driver 26 as the image reducing/enlarging operator 26Z enlarges the image of the document so that the margin areas, which are provided on the four edges of each print document in normal printing, that is, when the top/bottom borderless printing is not performed, become borderless in the top/bottom direction. That is, the print document 71L is enlarged at a magnification that causes a margin area 73L of the print document 71L to become top/bottom borderless. Similarly, the print document 71C is enlarged so as to cause a margin area 73C of the print document 71C to become top/bottom borderless, and the print document 71R is enlarged so as to cause a margin area 73R of the print document 71R to become top/bottom borderless. Further, the job is set so as to print the image shown in the lower section of FIG. 7 in which a left margin 72L and a right margin 72R are provided. The length in the longitudinal direction of each of the print documents 71L, 71C and 71R is 210 mm, and the length in the longitudinal direction of these print documents adjacently arranged is 630 mm. On the other hand, the length of “A4_3-panel_E2E_for_trim” in the longitudinal direction is 650 mm, which is 20 mm longer than the print document. In this embodiment, the driver 26 generates a job in which the margin 72L and the margin 72R are set to the same width of 10 mm.

As described above, in normal printing, the driver 26 provides the margins of a predetermined width on the four edges of each of the print documents 71L, 71C, and 71R. An example of the predetermined width is 2 mm on each of the four sides. The size of the long side (the side in the top/bottom direction shown in FIG. 7) of the A4 size is 297 mm. Thus, the 293 mm area inside of the margins is the image area of the print document in the top/bottom direction. Further, the size in the short side direction (the side in the longitudinal direction shown FIG. 7) of the A4 size is 210 mm. Thus, the 208 mm area inside of the margins is the image area of the print document in the longitudinal direction. The top/bottom borderless printing is achieved by matching the size of the image area of the print document to the size of the sheet in the top/bottom direction. Thus, the image is enlarged and printed at a magnification of 297 (mm)/293 (mm) (approximately 101.4%) based on the center in the top/bottom direction.

If the print document is enlarged at the same magnification in the longitudinal direction to maintain the same aspect ratio, the size of the image area of the print document in the longitudinal direction is approximately 210.9 mm, which exceeds the 210 mm area of the A4 size. The margins on both ends in the longitudinal direction are intended for preventing paper jams and cannot be eliminated. Thus, for the long sheet with “A4_3-panel_E2E_for_trim” selected for the top/bottom borderless printing, the length in the longitudinal direction is made 20 mm longer than 630 mm, which is three times the length of the short side of the A4 size, to ensure the margins on both ends in the longitudinal direction. The 10 mm margins on both ends are to be trimmed by the user after printing.

However, at the boundary between the print document 71L and the print document 71C, an area is generated where the image areas of both documents overlap. An overlapping area 75L is shown in FIG. 7. Similarly, an overlapping area 75R is generated in a part where the print document 71C and the print document 71R are adjacent to each other. Although there are some cases where the overlapping areas 75L and 75R do not pose a problem, it is anticipated that there are some cases where it is desirable to avoid overlapping. In this embodiment, the driver 26 as the setting receptor 26R receives an adjustment for shifting each position of the print documents 71L, 71C, and 71R. This allows the user to set the image areas of the enlarged print documents such that they do not overlap. In this case, if the adjacent print documents are too far apart, a blank space is generated between them, thus the position adjustment may be received within a range that does not generate the blank space. According to this aspect, the adjustable range of the print position of each print document can be limited to a range in which the adjacent print documents are not so far apart to generate the blank space between them. Alternatively, there may be an aspect in which it is preferable to receive a wide adjustment range even if there is some blank space between the two print documents. In that case, the adjustment may be received beyond the range where no blank space is generated between the two print documents. Further, if the wide adjustment range is preferable, the position adjustment may be received not only in the longitudinal direction but also in the top/bottom direction.

As in the aspect shown in FIG. 6, the driver 26 as the crease position determiner 26P determines the initial position of a cease 74L on the left side at a boundary position between the print documents 71L and 71C. The position is 210 mm away from the left end. The initial position of a cease 74R on the right side is a boundary position between the print documents 71C and 71R. The position is 420 mm away from the left end. The positions of the ceases 74L and 74R are each adjustable. According to this aspect, when the print document is not compatible with the size of the long sheet and consists of multiple print documents of the same standard size, the setting receptor displays on the screen an image in which each print document is arranged on the long sheet, and the cease positions, and the user can make an adjustment as necessary while viewing the screen.

The above is the job for printing with creases for 3-panel when the A4 size is set as the [Document size] 45, “A4_3-panel_E2E_for_trim” is set as the [Output paper size] 46, and other items are set to the specified conditions. On the other hand, both the [Document size] 45 and the [Output paper size] 46 may be set to “A4_3-panel_E2E_for_trim”. This setting is made when the print document of the “A4_3-panel_E2E_for_trim” size is created by an application. In this case, the driver 26 as the print data generator 26G generates the print data for the top/bottom borderless printing that matches the selected long sheet size. The job in which “A4_3-panel_E2E_for_trim” is set as the [Output paper size] 46 has been described. When “LT_3-panel_E2E_for_trim” (the size of the long sheet shown in the fifth column of FIG. 5) is set as the [Output paper size] 46, the job is the same as for “A4_3-panel_E2E_for_trim”, except that the size when folded in thirds is the letter size.

### Embodiment 3

Job with “A4_3-Panel_E2E” Set as Output Paper Size

Next, a case is described where the A4 size is selected as the [Document size] 45, the long sheet size “A4_3-panel_E2E” shown in FIG. 5 is selected as the output paper size, and other items are set to specified conditions. As in the case where “A4_3-panel” or “A4_3-panel_E2E_for_trim” is set, the driver 26 sends to the multifunction machine 10 the print job for providing the creases for 3-panel to the long sheet of the selected size.

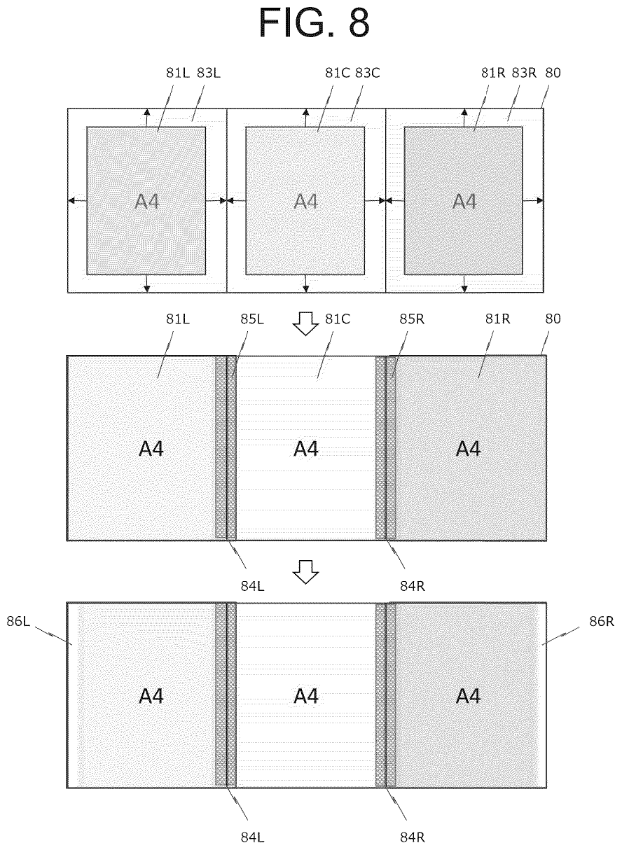

FIG. 8 is an explanatory diagram schematically showing an image printed on the long sheet by the above-mentioned job. As shown in FIG. 8, the print documents 71L, 71C, and 71R of the A4 size are arranged adjacently in the longitudinal direction, enlarged at a magnification that results in the top/bottom borderless printing, and printed on a long sheet 80 of the size “A4_3-panel_E2E”. This is the same as the job related to “A4_3-panel_E2E_for_trim” described in the embodiment 2. However, since the long sheet “A4_3-panel_E2E_for_trim” according to the embodiment 2 is to be trimmed at both ends by the user after printing, the size in the longitudinal direction is 650 mm, which is longer than three times the short side of the A4 size (630 mm). In contrast, the long sheet “A4_3-panel_E2E” according to this embodiment has the size in the longitudinal direction of 630 mm, the same as in the embodiment 1. In the embodiment 1, the document is not enlarged to make it top/bottom borderless, thus there are margins of a predetermined width (2 mm in the above example) on both ends in the longitudinal direction. However, in this embodiment, each print document is enlarged to make it top/bottom borderless, as in the embodiment 2, resulting in no margin on both ends in the longitudinal direction (see the middle section of FIG. 8). Thus, paper jams are prevented by providing gradation areas in which the image density at both ends of the print document gradually decreases the closer to both ends. That is, as shown in the lower section of FIG. 8, a gradation area 86L is provided at the left end of the long sheet 80, and a gradation area 86R is provided at the right end of the long sheet 80.

The gradation areas 86L and 86R may be generated on an application that creates the print document. However, the driver 26 as the print data generator 26G may set a job for the print data generator 26G to generate the gradation area. That is, the image former 17 of the multifunction machine 10 may be set to generate the gradation areas 86L and 86R.

As in the aspect shown in FIG. 7, the driver 26 as the crease position determiner 26P determines the initial position of a left cease 84L at a boundary position between the print documents 81L and 81C. The position is 210 mm away from the left end. The initial position of a right cease 84R is a boundary position between the print documents 81C and 81R. The position is 420 mm away from the left end. The positions of the ceases 84L and 84R are each adjustable. Further, similarly to the embodiment 2, the position adjustments of the print documents 81L, 81C, and 81R are received so that an overlapping area 85L and an overlapping area 85R are not generated. Considering that the long sheet is transported in the longitudinal direction, according to this aspect, if there is no or small margin at the leading and trailing ends required for printing due to the size of the long sheet, the image is formed so as to gradually decrease the image density near both ends, thereby ensuring the necessary margins. This makes it possible to achieve the top/bottom borderless printing, which eliminates the need for the user to trim both ends after printing.

The above is the job for printing with creases for 3-panel when the A4 size is set as the [Document size] 45, “A4_3-panel_E2E” is set as the [Output paper size] 46, and other items are set to the specified conditions. On the other hand, both the [Document size] 45 and the [Output paper size] 46 may be set to “A4_3-panel_E2E”. This setting is made when the print document of the “A4_3-panel_E2E” size is created in an application. In this case, the driver 26 as the print data generator 26G generates the print data for the top/bottom borderless printing that matches the selected long sheet size. The job in which “A4_3-panel_E2E” is set as the [Output paper size] 46 has been described. When “LT_3-panel_E2E” (the size of the long sheet shown in the sixth column of FIG. 5) is set as the [Output paper size] 46, the job is the same as for “A4_3-panel_E2E”, except that the size when folded in thirds is the letter size.

Settings for Other Items Related to Job Setting for Printing with Creases for 3-Panel

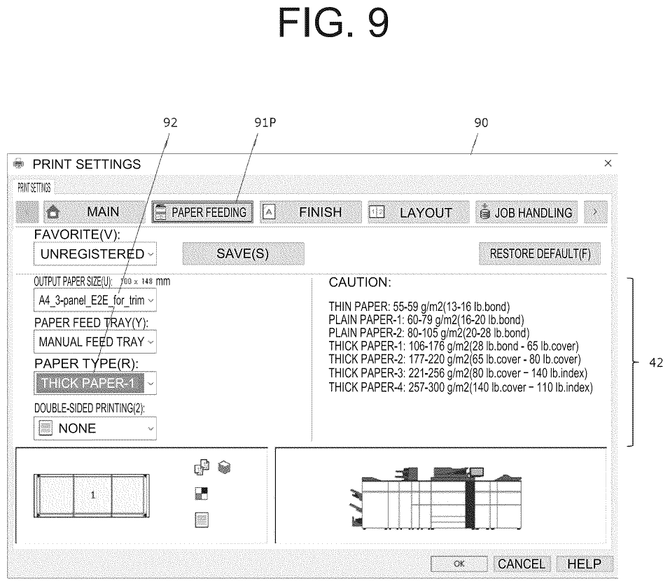

In the above-mentioned embodiments 1 to 3, it has been described that the job for printing with creases for 3-panel is instructed when any of the long sheets shown in FIG. 5 is selected as the output paper size, and other items are set to the specified conditions. The setting of other items in such a case is described below. FIG. 9 to FIG. 11 are explanatory diagrams showing examples of print setting screens related to other items.

FIG. 9 shows a state in which a [Paper feeding] tab 91P is selected on a print setting screen 90 similar to the screen shown in FIG. 4. As shown in FIG. 9, the driver 26 as the setting receptor 26R displays a [Paper type] 92 as one of the setting items in the setting area 42 to receive the selection of the paper type to be used for printing (the long sheet in this embodiment). Some of the selectable paper types are listed in a right part of the setting area 42. In this embodiment, among the paper types, the paper types for which creasing is valid are limited to “thick paper-1” and “thick paper-2”. A long (thin) paper with small basis weight, such as a thin paper or a plain paper, tends to be more prone to skewed feeding than a long paper with large basis weight. Thus, considering the stability of paper feeding, the paper types such as a thin paper and a plain paper are excluded from creasing. Note that, in addition to the above-mentioned “thick paper-1” and “thick paper-2”, user types 1 to 11 (not shown in FIG. 9) linked to information related to papers generated by the users themselves can also be the paper types for which creasing is valid. The driver 26 as the setting receptor 26R instructs the job for printing with creases for 3-panel on the condition that the “thick paper-1”, the “thick paper-2”, or any of the user types 1 to 11 of the suitable paper information is set as the [Paper type] 92.

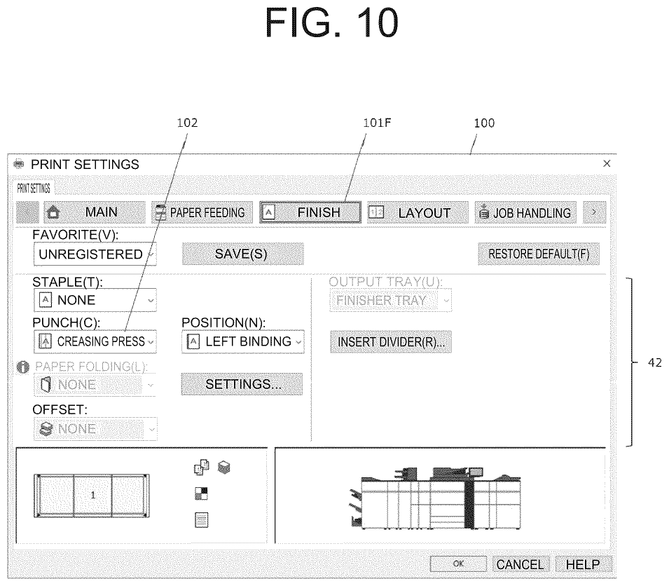

FIG. 10 shows a state in which a [Finish] tab 101F is selected on a print setting screen 100. As shown in FIG. 10, the driver 26 as the setting receptor 26R displays a [Punch] 102 in the setting area 42 as one of the setting items of the finish function to receive the setting for the punch function. In this embodiment, the creasing function can be set as one type of the [Punch] 102. This is because the creasing mechanism in this embodiment can also function as a multi-hole punch by replacing the unit. The driver 26 as the setting receptor 26R instructs the job for printing with creases for 3-panel on the condition that “creasing press” is set as the [punch] 102.

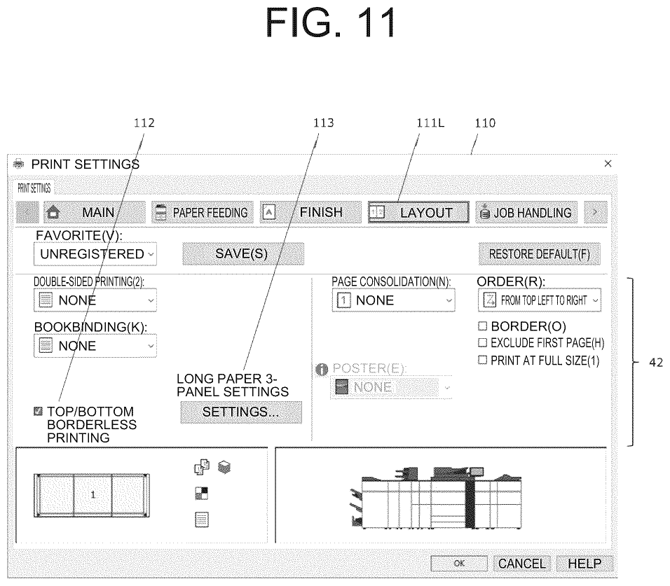

The settings related to the [Paper type] 92 and the [Punch] 102 described above are required conditions for instructing the job for printing with creases for 3-panel. The setting related to the top/bottom borderless printing and the setting related to a crease position adjustment and a print document position adjustment described below can be set although these conditions are not required for instructing the job for printing with creases for 3-panel. FIG. 11 shows a state in which a [Layout] tab 111L is selected on a print setting screen 110. As shown in FIG. 11, the driver 26 as the setting receptor 26R displays in the setting area 42 a check box for [Top/bottom borderless printing] 112 and a setting button for [Long paper 3-panel settings] 113 as the setting items for the finish function to receive these settings. The initial state of valid/invalid of the [Top/bottom borderless printing] 112 is linked to the selection of the [Document size] 45 and the [Output paper size] 46 as shown in FIG. 6 to FIG. 8. Further, it is also linked to the selection of various items shown FIG. 9 and FIG. 10. However, when an operation is performed to switch the setting of the [Top/bottom borderless printing] 112 between valid/invalid, the driver 26 as the setting receptor 26R receives this operation. The [Long paper 3-panel settings] 113 is described below, however, unless an operation is performed to change the setting, the crease position and the position of each print document are set to the initial positions shown in FIG. 6 to FIG. 8.

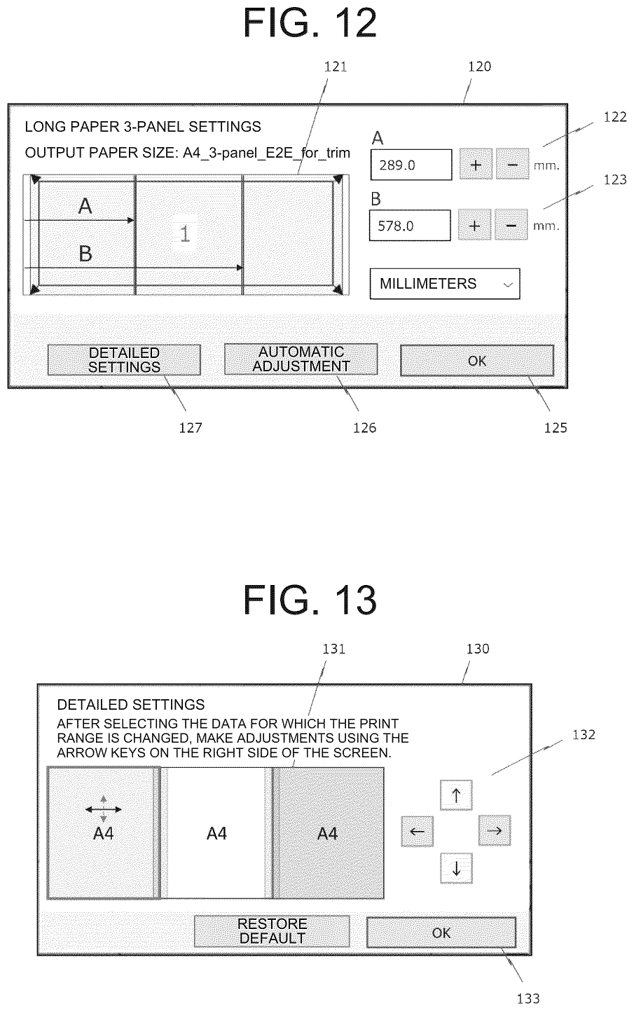

When the setting button for the [Long paper 3-panel settings] 113 is operated, the driver 26 as the setting receptor 26R opens a window for a long paper 3-panel setting screen different from the print setting screen 110. FIG. 12 is an explanatory diagram showing an example of a long paper 3-panel setting screen 120. As shown in FIG. 12, the long paper 3-panel setting screen 120 includes a crease position illustration 121 showing the image to be printed on the selected long sheet and the crease positions. In the crease position illustration 121, a position of the crease on the left side from the left end of the long sheet is indicated as A, and a position of the crease on the right side from the left end of the long sheet is indicated as B. To the right of the crease position illustration 121 are a crease position adjustment 122 for the crease position A on the left side, a crease position adjustment 123 for the crease position B on the right side, and a selection item for unit indicating the crease position. The driver 26 as the setting receptor 26R receives the setting for the crease position adjustment 122 for the crease position A on the left side and the setting for the crease position adjustment 123 for the crease position B on the right side. In the example shown in FIG. 12, numerical input or an increase or decrease in numerical value in increments of 0.1 (mm) is received for each of the crease positions A and B. Then, the crease positions in the crease position illustration 121 are updated according to the adjustment. According to this aspect, the setting receptor presents a position corresponding to the size of the selected long sheet as the initial position of the crease, and the user can make an adjustment as necessary while viewing, on the screen, the positions of the print document and the crease on the long sheet.

In a lower part of the long paper 3-panel setting screen 120, an [OK] button 125, an [Automatic adjustment] button 126, and a [Detailed settings] button 127 are provided. When the driver 26 as the setting receptor 26R receives an operation of the [OK] button 125, it adopts the crease position that is set at that time and closes the window of the long paper 3-panel setting screen 120. When the driver 26 as the setting receptor 26R receives an operation of the [Automatic adjustment] button 126, it sets the initial position of the crease according to the selected output paper size as the crease position, regardless of the crease position that is set at that time. When the driver 26 as the setting receptor 26R receives an operation of the [Detailed settings] button 127, it opens a window of a detailed setting screen, different from the long paper 3-panel setting screen 120, to receive an adjustment for the print position of each print document.

FIG. 13 is an explanatory diagram showing an example of a detailed setting screen 130. As shown in FIG. 13, the detailed setting screen 130 includes a print position illustration 131 indicating the print position of each print document. The print position illustration 131 shows the position of each A4-sized print document to be printed on the selected long sheet. When an operation for any of the print documents is received, the operated print document becomes a subject to the adjustment. In an example shown in FIG. 13, the print document on the left side is selected and displayed with a thick outline. Further, arrows indicating the adjustable directions are illustrated and superimposed on the selected print document. The adjustment to eliminate the overlapping area of the print documents that have been enlarged for the top/bottom borderless printing is made in the longitudinal direction. However, the adjustment may be received not only in the longitudinal direction but also in the top/bottom direction. The detailed setting screen shown in FIG. 13 is an example that receives the adjustment not only in the longitudinal direction but also in the top/bottom direction.

To the right of the print position illustration 131 is a print position adjustment 132 that receives an adjustment for the print position of the selected print document. The print position adjustment 132 is provided as an arrow button that moves the print position in each of the four directions. The driver 26 as the setting receptor 26R receives an operation of the print position adjustment 132 for the selected print document. Then, the driver 26 as the setting receptor 26R updates the position of the print document in the print position illustration 131 according to the adjustment. In a lower part of the detailed setting screen 130, an [OK] button 133 and a [Restore default] button are provided. When the driver 26 as the setting receptor 26R receives an operation of the [OK] button 133, it adopts the print position of each print document that is set at that time and closes a window of the detailed setting screen 130. When the driver 26 as the setting receptor 26R receives an operation of the [Restore default] button, it sets the position of the selected print document to the reference position (initial position) shown in FIG. 6 to FIG. 8, regardless of the print position that is set at that time. The above is the examples of the settings of other items when the driver 26 instructs the job for printing with creases for 3-panel. When the print document consisting of multiple documents of the same standard size is enlarged for the top/bottom borderless printing, the images of the adjacent print documents may overlap depending on the size of the margins of the original print documents. However, according to this aspect, the print position of each print document can be adjusted to avoid overlapping.

It should be understood that the present disclosure also includes any combination of the above-mentioned multiple aspects.

In addition to the above-mentioned embodiment, various modifications of the present disclosure can be made. These modifications should not be construed as falling outside the scope of the present disclosure. The invention according to the present disclosure should include all modifications that are equivalent to the scope of the claims and fall within the scope of the present disclosure.

Further, each functional block or feature of the apparatus used in the above-mentioned embodiments can be implemented or performed by an electric circuit, for example, an integrated circuit or a plurality of integrated circuits. The electric circuit designed to perform the functions described in the present specification may include a general-purpose processor, a digital signal processor (DSP), an application specific integrated circuit (ASIC), a field programmable gate array (FPGA) or other programmable logic devices, a discrete gate or a transistor logic, a discrete hardware component, or any combination of these. The general-purpose processor may be a microprocessor, or a traditional processor, controller, microcontroller, or state machine. The above-mentioned electric circuit may be configured with a digital circuit or an analog circuit. Further, if an integrated circuit technology emerges that replaces the current integrated circuit due to advances in semiconductor technology, one or more aspects of the present disclosure may also use a new integrated circuit based on such technology.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An information processing apparatus capable of communicating with an image forming apparatus that includes an image former that forms an image on a long sheet and a creasing mechanism that provides a crease for folding to the long sheet at multiple sites in a longitudinal direction, comprising a controller that receives a setting for a job related to the image formation and sends an instruction to the image forming apparatus, wherein the controller performs:
receiving a selection of the long sheet, a setting of a creasing function that provides the crease to the selected long sheet, and a setting of a position of the crease;
determining the position where the crease is provided according to the setting; and
displaying, on a screen of the information processing apparatus, a display image corresponding to the selected long sheet on which the display image of a print document and the position of the crease are superimposed, thereby receiving the setting of the position of the crease.

2. The information processing apparatus according to claim 1, wherein the controller performs:
displaying on the screen a predetermined position corresponding to a size of the selected long sheet as an initial position of the crease; and
receiving an adjustment that changes the position of each crease in the longitudinal direction from the initial position, moving the position of the crease on the screen according to the received adjustment, and displaying the resulting position of the crease.

3. The information processing apparatus according to claim 2, wherein the controller arranges, adjacently in the longitudinal direction, the print documents of a same standard size, which number is one greater than the number of the creases, and if the long sheet is longer than a length of the arranged multiple print documents, the controller provides margins on both ends of the long sheet in the longitudinal direction and sets a boundary between the adjacent print documents as the initial position of each crease.

4. The information processing apparatus according to claim 3, wherein:
the print document consists of multiple documents of the standard size; and
the controller performs:
expanding the print document so as to eliminate a margin area of each print document in a top/bottom direction perpendicular to the longitudinal direction of the long sheet; and
displaying the image corresponding to the size of the long sheet on which the image in which the enlarged print documents are arranged in the longitudinal direction and the creases are superimposed, thereby receiving the adjustment of a print position of each print document.

5. The information processing apparatus according to claim 4, wherein the controller receives the adjustment of the print position within a range in which no blank space is generated between the adjacent print documents.

6. The information processing apparatus according to claim 3, wherein the controller generates and outputs print data according to the setting, and if a length in the longitudinal direction of the multiple print documents arranged in the longitudinal direction and a length of the selected long sheet in the longitudinal direction are the same or have a difference equal to or less than a predetermined value, the controller generates the print data in which a density of the image near both ends of the arranged multiple print documents is adjusted to gradually decrease toward both ends.

7. The information processing apparatus according to claim 1, wherein the controller receives the setting for the creasing function that folds the long sheet in thirds.

8. A method for setting long sheet printing, wherein in an information processing apparatus capable of communicating with an image forming apparatus that includes an image former that forms an image on a long sheet and a creasing mechanism that provides a crease for folding to the long sheet at multiple sites in a longitudinal direction, a controller that receives a setting for a job related to the image formation and sends an instruction to the image forming apparatus performs:
receiving a selection of the long sheet, a setting of a creasing function that provides the crease to the selected long sheet, and a setting of a position of the crease; and
determining the position where the crease is provided according to the setting, wherein in the receiving of the setting, the controller displays, on a screen of the information processing apparatus, a display image corresponding to the selected long sheet on which the display image of a print document and the position of the crease are superimposed, thereby receiving the setting of the position of the crease.

9. An image forming apparatus comprising:
an image former that forms an image on a long sheet;
a creasing mechanism that provides a crease for folding to the long sheet at multiple sites in a longitudinal direction;
a communication circuit that communicates with an external information processing apparatus; and
a job controller that performs processing in response to a job setting and instruction related to the image formation received from the information processing apparatus via the communication circuit,
wherein the job controller performs, if the received job setting includes a creasing function, a control for forming an image on a specified long sheet and provision of the crease at a specified position on the long sheet.
